(19) United States
(12) Patent Application Publication
(10) Pub. No.: US 2025/0252766 A1
(43) Pub. Date: Aug. 7, 2025

(54) SYSTEMS AND METHODS FOR AUTOMATICALLY RECOGNIZING ORDER CONTENT ON PRINTED ORDER FORM USING AI TECHNOLOGIES

(71) Applicants: Harry Tu, Pleasanton, CA (US); Wei Zhu, Beijing (CN)

(72) Inventors: Harry Tu, Pleasanton, CA (US); Wei Zhu, Beijing (CN)

(21) Appl. No.: 18/649,647

(22) Filed: Apr. 29, 2024

Related U.S. Application Data
(60) Provisional application No. 63/550,831, filed on Feb. 7, 2024.

(51) Int. Cl. G06V 30/19; G06V 10/75

(52) U.S. Cl. CPC G06V 30/19073; G06V 10/751; G06V 30/19013

(57) ABSTRACT

The present disclosure relates to order recognition methods and systems using artificial intelligence (AI) technologies. In one example, a method includes obtaining, using an image sensor, an image of a first page of an ordering form. The ordering form includes one or more pages, each page including names of items and indicator fields. At least one indicator field of the first page is marked to indicate a corresponding item being ordered. The method further includes determining an order based on the image of the first page and one or more templates associated with the one or more pages of the ordering form. The order includes one or more items selected on the first page of the ordering form. Each template includes items and locations of indicator fields associated with a corresponding page of the ordering form. The method further includes transmitting the determined order to an order processing system.

### CROSS-REFERENCE TO RELATED APPLICATIONS

This application claims the benefit of U.S. Provisional Application Ser. No. 63/550,831 filed on Feb. 7, 2024, the entire contents of which are hereby incorporated by reference in its entirety.

### TECHNICAL FIELD

The present disclosure generally relates to artificial intelligence (AI).

### BACKGROUND

In dining and retail establishments, it is common to place orders using paper menus with various dishes and products printed on them. Customers can indicate their choices by marking checkboxes next to the items they want, sometimes also specifying the quantity of each dish or product they are ordering. The staff collects the marked menus from the customers and then manually enters the order information into the restaurant management system based on the selections.

### SUMMARY

The present disclosure relates to order recognition methods and systems using artificial intelligence (AI) technologies. An example method performed by one or more computers includes obtaining, using an image sensor, an image of a first page of an ordering form. The ordering form includes one or more pages, each page including names of items and indicator fields. At least one indicator field of the first page is marked to indicate a corresponding item being ordered. The method further includes determining an order based on the image of the first page and one or more templates associated with the one or more pages of the ordering form. The order includes one or more items selected on the first page of the ordering form. Each template includes items and locations of indicator fields associated with a corresponding page of the ordering form. The method further includes transmitting the determined order to an order processing system.

In some instances, determining the order includes: automatically and without user input, identifying, using a statistic comparison algorithm, a template from the one or more templates that is corresponding to the image of the first page; determining items in the image of the first page based on items in the identified template; determining indicator fields in the image of the first page based on locations of indicator fields in the identified template; and for each indicator field in the image of the first page, determining an order quantity of an item indicated by the indicator field.

In some instances, determining the order quantity of the item indicated by the indicator field includes: determining whether the indicator field is selected; and determining that the order quantity of the item is one in response to determining that the indicator field is selected.

In some instances, determining whether the indicator field is selected includes determining whether the indicator field is selected using an algorithm to detect a change in an image of the indicator field caused by a selection of the indicator field.

In some instances, determining whether the indicator field is selected includes determining whether the indicator field is selected using a deep learning recognition algorithm and training data. The training data includes at least one of: an image of an unselected indicator field; an image of a selected indicator field; and an image of an indicator field that is selected by a mistake and has a correction to fix the mistake.

In some instances, determining the order quantity of the item indicated by the indicator field includes: recognizing a handwritten number filled in the indicator field using optical character recognition (OCR); and determining that the order quantity of the item is the recognized handwritten number.

In some instances, determining the order further includes displaying the order to a user and updating the order in response to receiving an input from the user to modify the order.

In some instances, the ordering form includes forms of different types, and each of the forms of different types includes at least one page.

In some instances, the method further includes obtaining an image of a second page of the ordering form and automatically and without user input, identifying, using a statistic comparison algorithm executed by the one or more computers, a second template from the one or more templates that is corresponding to the image of the second page. The order is determined further based on the image of the second page. The order further includes at least another item selected on the second page.

In some instances, each of the items includes at least one of a product or a service, the product includes a food, and the ordering form includes a restaurant menu.

In some instances, each template is generated by: obtaining an image of a corresponding page of the ordering form; recognizing item names in the image of the corresponding page using OCR; determining items based on the recognized item names and an item database; and determining locations of indication fields in the image of the corresponding page.

In some instances, determining the locations of the indication fields in the image of the corresponding page includes automatically detecting the indication fields in the image of the corresponding page based on at least one of a geometric shape detection algorithm or a deep learning object recognition algorithm.

In some instances, determining the locations of the indication fields in the image of the corresponding page includes: displaying the image of the corresponding page to a user; receiving a user input representing at least one indication field in the image of the corresponding page that is identified by the user; and determining the locations of the indication fields in the image of the corresponding page based on the at least one indication field identified by the user.

An example system includes an image sensor, one or more computers, and one or more storage devices. The one or more storage devices store instructions that when executed by the one or more computers cause the one or more computers to perform operations. The operations include obtaining, using the image sensor, an image of a first page of an ordering form. The ordering form includes one or more pages. Each page includes names of items and indicator fields. At least one indicator field of the first page is marked to indicate a corresponding item being ordered. The operations further include determining an order based on the image of the first page and one or more templates associated with the one or more pages of the ordering form. The order includes one or more items selected on the first page. Each template includes items and locations of indicator fields associated with a corresponding page. The operations further include transmitting the order to an order processing system.

In some instances, determining the order includes: automatically and without user input, identifying, using a statistic comparison algorithm, a template from the one or more templates that is corresponding to the image of the first page; determining items in the image of the first page based on items in the identified template; determining indicator fields in the image of the first page based on locations of indicator fields in the identified template; and for each indicator field in the image of the first page, determining an order quantity of an item indicated by the indicator field.

In some instances, determining the order quantity of the item indicated by the indicator field includes: determining whether the indicator field is selected; and determining that the order quantity of the item is one in response to determining that the indicator field is selected.

In some instances, determining whether the indicator field is selected includes determining whether the indicator field is selected using an algorithm to detect a change in an image of the indicator field caused by a selection of the indicator field.

In some instances, determining whether the indicator field is selected includes determining whether the indicator field is selected using a deep learning recognition algorithm and training data. The training data includes at least one of: an image of an unselected indicator field; an image of a selected indicator field; and an image of an indicator field that is selected by a mistake and has a correction to fix the mistake.

In some instances, determining the order quantity of the item indicated by the indicator field includes: recognizing a handwritten number filled in the indicator field using OCR; and determining that the order quantity of the item is the recognized handwritten number.

An example non-transitory computer-readable storage medium stores instructions that when executed by one or more computers cause the one or more computers to perform operations. The operations include obtaining, using the image sensor, an image of a first page of an ordering form. The ordering form includes one or more pages. Each page includes names of items and indicator fields. At least one indicator field of the first page is marked to indicate a corresponding item being ordered. The operations further include determining an order based on the image of the first page and one or more templates associated with the one or more pages of the ordering form. The order includes one or more items selected on the first page. Each template includes items and locations of indicator fields associated with a corresponding page. The operations further include transmitting the order to an order processing system.

### DESCRIPTION OF DRAWINGS

FIG. 1 illustrates an example system for performing the subject matter described in the present disclosure.

FIG. 2 illustrates an example ordering form.

FIG. 3 illustrates examples of different types of indicator fields.

FIG. 4 illustrates an example document scanner.

FIG. 5 illustrates an example operation of the system of FIG. 1.

FIGS. 6A-6B illustrate an example process of a registration step of the operation in FIG. 5.

FIGS. 7A-7C illustrate a flow chart of an example method for performing the registration step.

FIG. 8 illustrates an indicator field selected by a user.

FIG. 9 illustrates an example process of a recognition step of the operation in FIG. 5.

FIGS. 10A-10D illustrate a flow chart of an example method for performing the recognition step.

FIG. 11 illustrates example models and data flows for the registration step.

FIG. 12 illustrates example models and data flows for the recognition step.

FIG. 13 illustrates example training data for a deep learning model.

### DETAILED DESCRIPTION

The process of manually transcribing orders from paper menus into the system is time-consuming, labor-intensive, and prone to errors, as the staff may enter the wrong items and provide incorrect dishes or products, thereby leading to customer complaints. The present disclosure provides automated methods for accurately and automatically capturing the ordering information from the customers' marked menus. For example, the present disclosure provides systems and methods that aim at obtaining a photograph by taking a picture of a paper order menu after the guests have checked off their selections. The solution can then use computer image processing technology or an AI model to recognize and analyze the photograph, where the dishes and the quantity of each dish selected by the customers or guests on the order menu can be accurately and automatically read, while allowing the service staff of restaurants and other service venues to potentially review, modify, and confirm the orders before being stored in a database and/or transmitted to a point-of-sale (POS) or backend system for order processing or completion.

The techniques described in the present disclosure include one or more of the following features.

1. An automatic recognition method for guest checkmarks and handwritten order menus, divided into two steps: order menu registration and order recognition, capable of accurately identifying the selected products and quantities marked by the guests.

2. Two types of order menu registration algorithms: One is the automatic identification of standard geometric shapes used for checking off and entering the number of dishes, such as checkboxes, check circles, lines, brackets, etc. The other is identification through manually guided markings of checkboxes, circles, lines, brackets, and others, followed by automatic recognition.

3. A fast automatic recognition algorithm for identifying selected checkboxes. By comparing pixels, the algorithm can detect the selected checkboxes and accurately identify various order checking scenarios, such as: 1. Not selected; 2. Selected; 3. Selection deleted or obscured.

4. AI algorithms and models that, through training on annotated datasets, generate deep learning models capable of accurately recognizing various order checking scenarios: 1. Not selected; 2. Selected; 3. Selection deleted or obscured; 4. Quantity.

5. A guided user confirmation process, as well as a correction mechanism based on user confirmation, which can quickly implement automatic data entry of the order content on the order menu, building upon the computer algorithm and AI recognition.

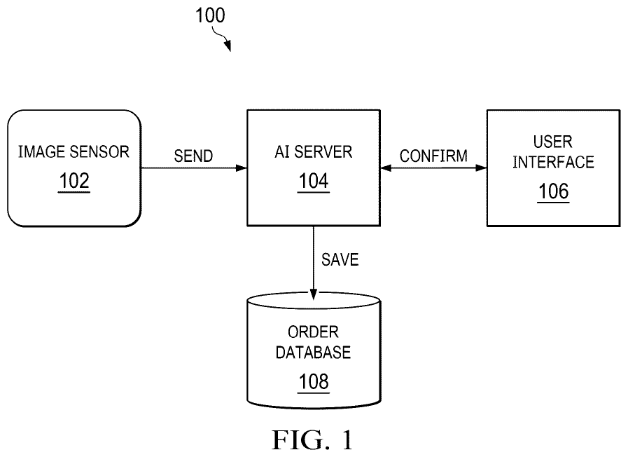

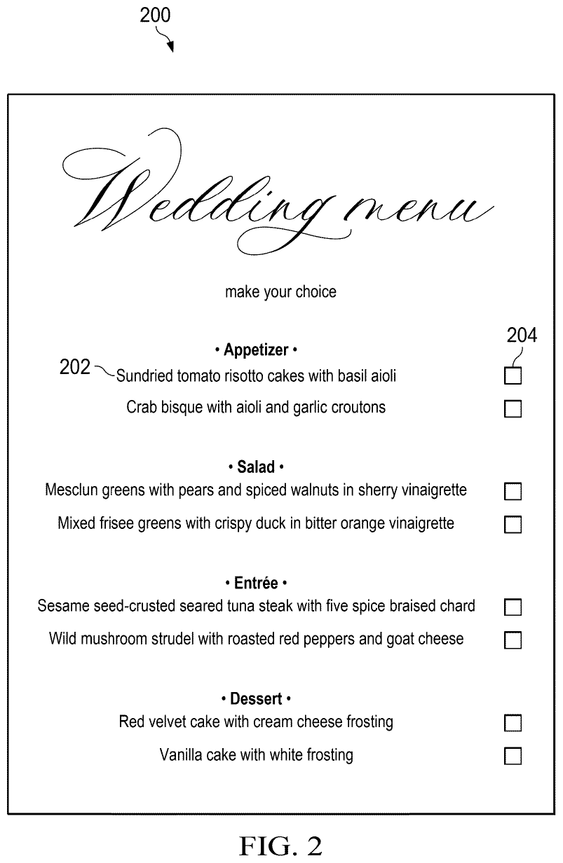

FIG. 1 illustrates an example system 100, which can be used to perform the subject matter described herein. As shown in FIG. 1, system 100 can include an image sensor 102, an artificial intelligence (AI) server 104, a user interface (UI) 106, and an order database 108. The components of system 100 can be integrated into a single device or can belong to multiple separate devices coupled together through wired connections, wireless connections, and/or the Internet. The image sensor 102 is configured to take photographs of a document to obtain an image (e.g., a digital image) of the document. In some implementations, the document can be an ordering form, such as a restaurant ordering menu as shown in FIG. 2. The AI server 104 can include one or more processors and can be tasked with recognizing and inferring content of the ordering form. The content to be recognized can include at least one of item names (such as dish names in the restaurant ordering menu as shown in FIG. 2), indicator fields (e.g., checkboxes), or other information in the ordering form (such as food categories as shown in FIG. 2, item descriptions, the restaurant's name and contact information, or introduction of the restaurant). The UI 106 can be a display interface, which shows the results of the AI server 104's recognition and inferences and allows a user (e.g., a database manager or a service staff) to modify and confirm these results. The order database 108 can be a database that stores data related to the orders. The order database 108 can be located in a dedicated server for document or order storage. In some implementations, the order database 108 can be integrated into a point-of-sale (POS) system, such as a POS system of a restaurant.

The ordering form can include one or more pages. Each page can include names of items and indicator fields associated with the items. Each indicator field can be filled or marked to indicate that a corresponding item is being ordered. FIG. 2 shows an example of an ordering form 200. In this example, the ordering form 200 is an ordering menu that a restaurant or catering service has provided for a wedding. The ordering menu 200 has one page that includes a list of dishes 202 (examples of the items), and each dish has a checkbox 204 (an example of the indicator field) adjacent to the dish. A guest or a customer can select a checkbox 204 in the ordering menu 200 to order the dish 202 associated with the checkbox 204. In some implementations, the ordering form can include multiple forms, and the multiple forms can be of different types. Each of the multiple forms can include at least one page. For example, a Japanese restaurant can have a sushi menu and a regular dinner menu. In another example, a restaurant can have a lunch menu, an entree menu, a dessert menu, and a wine menu, and these menus can be in separate menu books.

While in this disclosure some examples are described in the context of a restaurant menu, it is understood that techniques described in the disclosure are applicable to processing any suitable types of documents or forms such as purchase orders and enquiry forms. In some implementations, an item in the ordering form can be a product, a service, or a combination of both. In some implementations, implementations of the present disclosure can also be used for the scanning of enquiry forms (e.g., investigation forms), and automatic entry of the provided submissions, selections, or input provided on those forms. An example of the enquiry form can be a medical history enquiry form that a patient fills out when visiting a doctor. The medical history form can include one or more of a list of medical issues or conditions the patient is experiencing, personal health history information, or family health history information of the patient. In some instances, the patient can provide medical history information by checking one or more checkboxes in the medical history enquiry form.

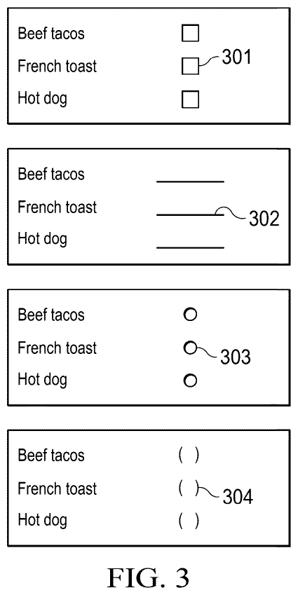

The indicator field can have various forms. In some implementations, the indicator field can be selected to indicate that a corresponding item is being ordered. In some other implementations, a customer can enter a number in the indicator field to indicate that a quantity of the selected item are being ordered. FIG. 3 shows examples of different types of indicator fields. Indicator field 301 is a square checkbox. Indicator field 302 is a horizontal line, where customers can place a checkmark or write numbers above the line. Indicator field 303 is a circle, where customers can place a checkmark inside the circle. Indicator field 304 are a pair of parentheses, where customers can place a checkmark or write numbers inside them.

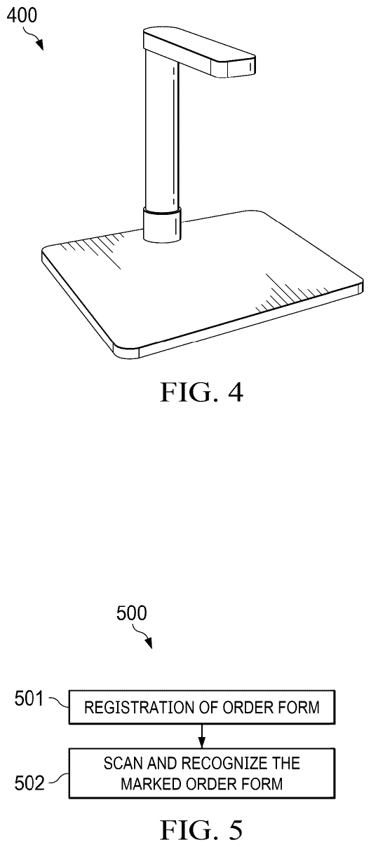

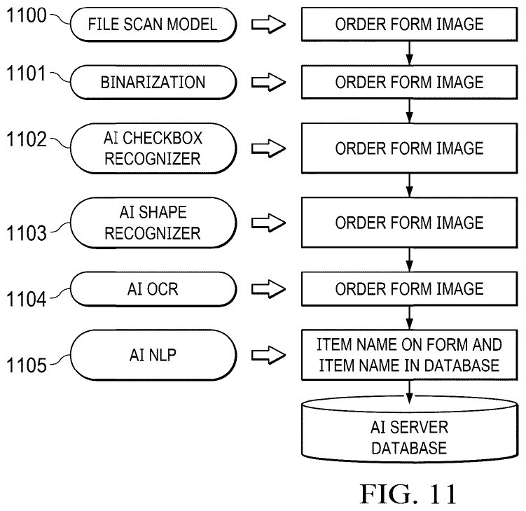

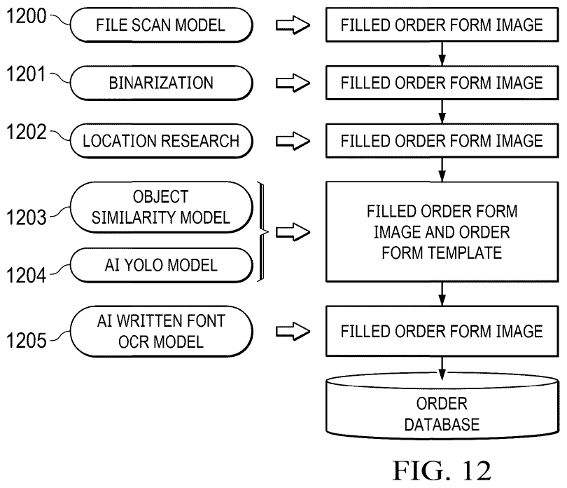

Returning to FIG. 1, the image sensor 102 can be any suitable device (e.g., a camera or a scanner) that can take a photograph of the ordering form or scan the ordering form. For example, the image sensor 102 can be devices such as iPhones or iPads that have a “File Scan” feature as well as a built-in camera capable of capturing a photo. In some instances, the “File Scan” feature can be used to conveniently obtain clear scanned documents. In some instances, operating iPhones and iPads can be cumbersome. For convenience and accuracy in a formal business setting, a scanner (e.g., a document scanner 400 as shown in FIG. 4) may be used to quickly scan the ordering form. The image sensor 102 can transmit one or more images of the ordering form to the AI server 104. The AI server 104 can employ one or more suitable models and/or algorithms (e.g., models and algorithms described below with reference to FIGS. 11 and 12) to process, analyze, and recognize the document to identifying the marked indicator fields, as well as the corresponding items and the quantity of each item. The AI server 104 then presents the recognized results on the UI 106 for user confirmation. If the user believes that a piece of information has been incorrectly recognized, the user can delete the information via the user interface, or modify the results of the AI analysis via manual inputs. The AI server 104 may re-identify and re-assess the deleted information, and then may present it on the UI 106 for further confirmation. Once the information has been confirmed on the UI 106, it can be stored in the order database 108 in a suitable database format.

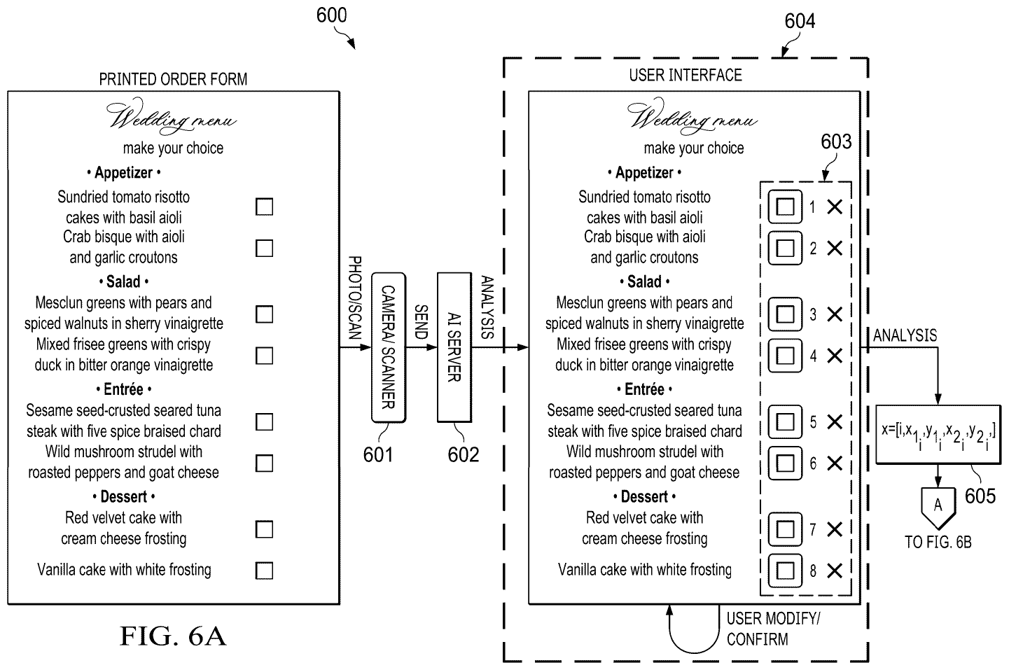

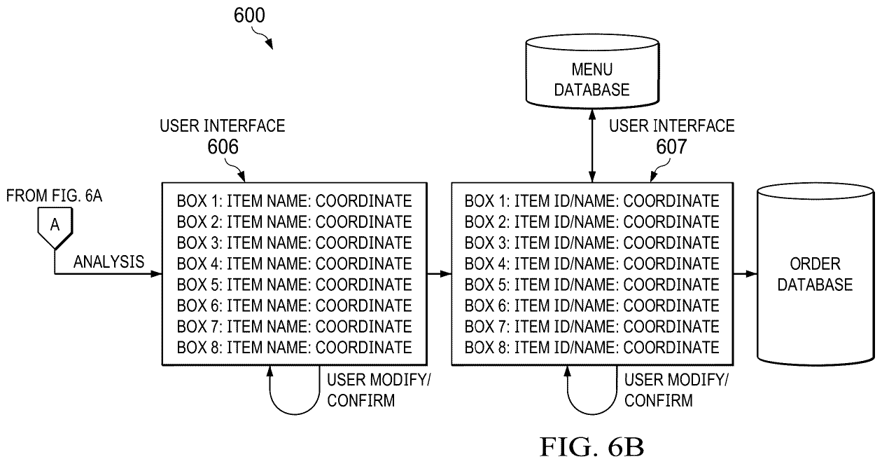

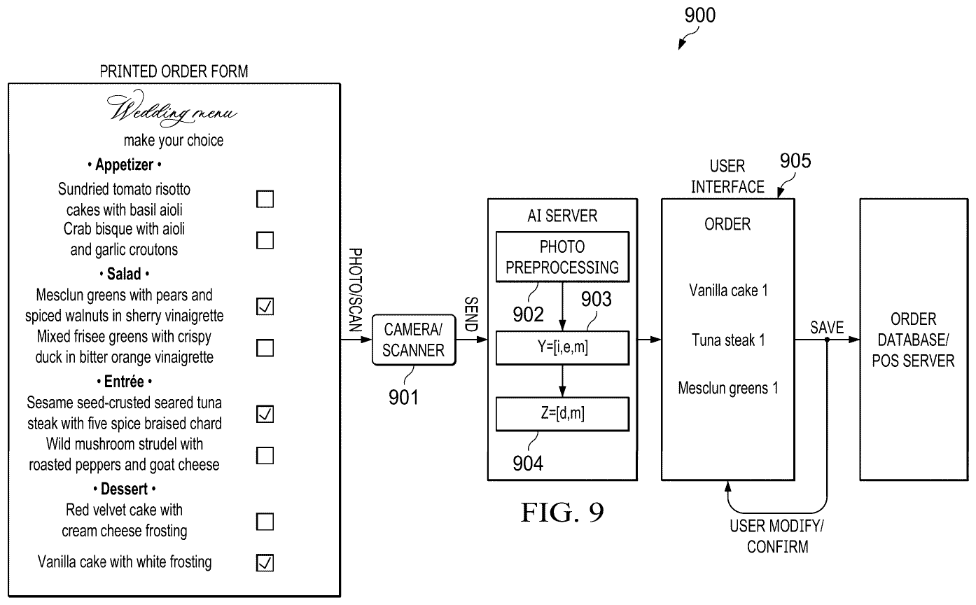

FIG. 5 shows an example operation 500 of the system 100 of FIG. 1. In some implementations, as illustrated in FIG. 5, the operation 500 of the system 100 can be divided into two steps 501 and 502. The step 501 is registration of an order form (also referred to as a registration step), and the step 502 is scanning and recognition of a filled ordering form (also referred to as a recognition step). In some implementations, the order form can be an ordering menu of a restaurant (e.g., the ordering menu 200 of FIG. 2). The ordering menu can include indicator fields (e.g., indicator fields or checkboxes 301-304 of FIG. 3). The filled ordering form can be a copy of the ordering menu filled or completed by a customer. In some instances, the filled copy of the ordering menu can include one or more marked checkboxes. A marked checkbox can include a check mark or a number in the checkbox. The registration step 501 can include registering the ordering menu (e.g., an empty paper copy of the ordering menu that is not filled or marked). For example, some detailed operations in the registration step 501 will be described below with reference to FIGS. 6A-6B, 7A-7C, 8, and 11. The recognition step 502 can include the scanning and recognition of the ordering menu after the customer has ticked and filled out the ordering menu. For example, some detailed operations in the recognition step 502 will be described below with reference to FIGS. 9, 10A-10D, and 12-13.

FIGS. 6A-6B illustrate an example process 600 of the registration step (e.g., the registration step 501 of FIG. 5). The process 600 can include sub-steps 601-605 as shown in FIG. 6A and sub-steps 606 and 607 as shown in FIG. 6B.

Sub-step 601 can include obtaining, using a camera or scanner (e.g., the image sensor 102 of FIG. 1), a photo or a scanned document of an ordering menu (e.g., an unfilled copy of the ordering menu 200 of FIG. 2).

Sub-step 602 can include preprocessing, using an AI server (e.g., the AI server 104 of FIG. 1), the photo or the scanned document. This preprocessing work can include, for example, one or more of the following operations.

1. Correcting (e.g., using the document scanning correction model 1100 of FIG. 11) the photo or the scanned document to keep the image of the ordering menu upright.

2. Converting the image to a binary format (e.g., using the binarization model 1101 of FIG. 11) or a grayscale format, such as by removing color and retaining only the grayscale image.

3. Other suitable processes to keep the image clear and prepared for analysis. For example, shadows can be removed from the images.

Sub-step 603 can include processing, using the AI server, the photo or the scanned document for recognition. This processing work can include, for example, identifying (e.g., using the model 1102 of FIG. 11) geometric shapes such as squares, lines, circles, and brackets in the image that are used for checkboxes and number entry.

The steps designed above can use any suitable object detection and/or recognition techniques including but not limited to, OpenCV's geometric shape detection or deep learning object recognition technology. An alternative approach is to manually mark the geometric shapes used for checkbox selection, allowing the AI server to recognize the same geometric shapes from the image, which can result in higher accuracy.

The alternative approach can include, for example, one or more of the following operations.

1. The AI server can display the ordering menu photo on an UI (e.g., the UI 106 of FIG. 1).

2. The user can use a mouse (or a finger if the user is using a touch screen device such as an iPad) to mark out a checkbox shape on the ordering menu photo. As shown in FIG. 8, the ordering menu can include a checkbox 801, and the user can draw a box 802 surrounding the checkbox 801 to select it.

3. The AI server can analyze the geometric shape from the region marked by the user, and then can search for shapes identical to that geometric shape throughout the entire image (e.g., using the model 1103 of FIG. 11). In doing so, each of the checkboxes on the ordering menu can be located.

4. The user can specify whether the checkboxes on this menu are for ticking off or for entry types. Entry types may require a number to be entered, representing an order quantity of the selected item.

Sub-step 604 can include marking and displaying, using the AI server, the identified checkboxes on the UI. Users can modify these on the UI, for example, by deleting an incorrectly identified checkbox or drawing a box around a missed checkbox, prompting the AI server to recognize the checkbox again.

Sub-step 605 can include recognizing, using the AI server, information about the checkboxes. In some instances, the recognized information can include sequence numbers and coordinates of corresponding checkboxes. The recognized checkbox information can be saved as an array X:

X=[i,x₁_{ᵢ},y₁_{ᵢ},x₂_{ᵢ},y₂_{ᵢ}],i∈1,2,3 . . . n,

where i is the sequence number assigned by the AI server, (x₁_{ᵢ}, y₁_{ᵢ}) are the x and y coordinates of the top-left corner of a minimum bounding rectangle of the checkbox, and (x₂_{ᵢ}, y₂_{ᵢ}) are the x and y coordinates of the bottom-right corner of the minimum bounding rectangle of the checkbox. In some implementations, regardless of whether the checkbox is a rectangle, circle, or bracket, a rectangle enclosing the checkbox is taken as the minimum bounding rectangle. In some implementations, the minimum bounding rectangle is the smallest rectangle enclosing the checkbox. In some implementations, if the checkbox is a horizontal line, a square formed with the horizontal line as the base is used as the minimum bounding rectangle.

Moving to FIG. 6B, sub-step 606 can include identifying, using the AI server, a dish or product name adjacent to each checkbox (e.g., using the model 1104 of FIG. 11). Any suitable Optical Character Recognition (OCR) services can be used for recognition, including but not limited to Amazon Web Services (AWS) OCR. The name of the dish can be saved or included in the array X obtained from sub-step 605. The array X can be changed to:

X=[i,x₁_{ᵢ},y₁_{ᵢ},x₂_{ᵢ},y₂_{ᵢ},s],i∈1,2,3 . . . n,

where the variable s is the recognized dish or product name string. The AI server can display the identified sequence number and dish/product name on the user interface, where the user can make modifications. Once the modifications are verified by the user to be correct, they can be confirmed.

Sub-step 607 can include determining the dishes based on the dish names obtained in sub-step 606 and a menu/product database. For example, the system can access the menu/product database through an Application Programming Interface (API) (e.g., the menu table database in the restaurant's POS system), use AI Natural Language Processing (NLP) techniques (e.g., the model 1105 of FIG. 11) to query for dish/product names similar to those identified in sub-step 606, establish associations, and display them on the user interface for user modification and confirmation. After confirming that they are correct, the information can be saved to array X, which at this point is as follows:

X=[i,x₁_{ᵢ},y₁_{ᵢ},x₂_{ᵢ},y₂_{ᵢ},d],i∈1,2,3 . . . n,

where d represents an identification (ID) of the corresponding dish/product name in the menu/product database. The system can save the above array X to the database for use in the recognition of ordering menus (e.g., the recognition step 502 of FIG. 5).

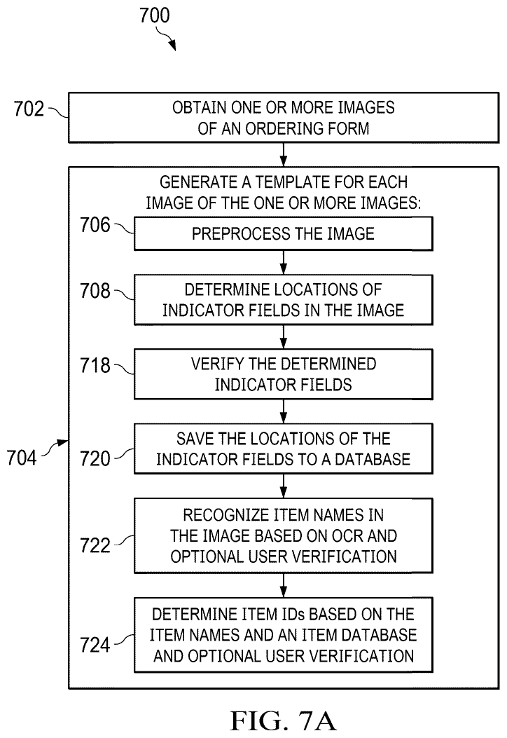

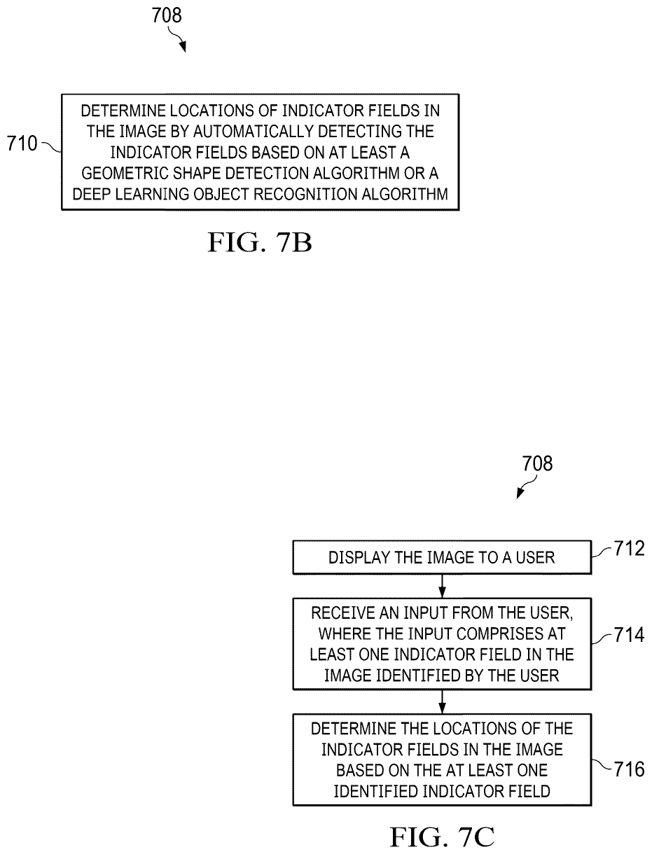

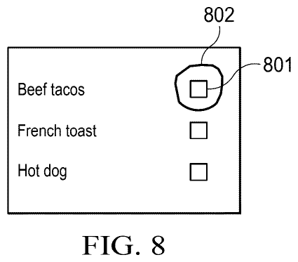

FIGS. 7A-7C illustrate a flow chart of an example method 700 for the registration step (e.g., the registration step 501 of FIG. 5). Method 700 can be performed by any suitable device or system including, for example, the system 100 of FIG. 1.

As shown in FIG. 7A, at operation 702, the system can obtain one or more images of an ordering form. The ordering form can include one or more pages. The one or more images can be image(s) of the one or more pages of the ordering form. For example, each image can be an image of an unfilled copy of a corresponding page of the ordering form and can be obtained using the image sensor 102 of FIG. 1. The image sensor 102 can send the generated one or more images to the AI server 104 of FIG. 1. In some implementations, the ordering form includes forms of different types each including at least one page. Each page of the ordering form can include names of items and indicator fields associated with the items. An indicator field can be filled or marked to indicate that a corresponding item is being ordered.

At operation 704, the system can generate (e.g., using the AI server 104) a template for each of the one or more images. In some implementations, as shown in FIG. 7A, a respective template for each image can be generated by performing operations 706, 708, 718, 720, 722, and 724.

At operation 706, the system can preprocess (e.g., using the AI server 104) the image to make the image suitable for the following operations. For example, the system can use the AI server 104 to preprocess (e.g., using the document scanning correction model 1100 or the binarization model 1101 of FIG. 11) the image as described in sub-step 602 of FIG. 6A.

At operation 708, the system can determine (e.g., using the AI server 104) locations of the indication fields in the image of the corresponding page. In some implementations, as shown in FIG. 7B, operation 708 includes operation 710, where the system can determine the locations of the indication fields by automatically detecting the indication fields in the image. For example, the automatic detection can be based on at least one of a geometric shape detection algorithm or a deep learning object recognition algorithm as described in sub-step 603 of FIG. 6A. Alternatively, as shown in FIG. 7C, operation 708 can include operations 712-716 based on user interactions (e.g., as described in sub-step 603 of FIG. 6A). For example, at operation 712, the system can display the image to a user (e.g., via the UI 106 of FIG. 1). In some implementations, the user can be a database manager or administrator of a restaurant. The user can identify and mark out an indicator field in the image (e.g., as shown in FIG. 8). In some implementations, if the image includes different types of indicator fields, the user can mark out one indicator field for each type. In some implementations, user can specify whether the identified indicator field is for ticking off or for entry types. The entry types may require a number to be entered, representing an order quantity of the selected item. At operation 714, the system can receive (e.g., via the UI 106 of FIG. 1) a user input representing at least one indication field in the image that is identified by the user. At operation 716, the system can determine the locations of the indication fields in the image based on the at least one indication field identified by the user. For example, the system can use the AI server 104 to analyze the geometric shape from the region marked by the user, and then can search for shapes identical to that geometric shape throughout the entire image. In doing so, each of the indication fields in the image can be located.

In some implementations, at operation 718, the system can verify the indicator fields determined at operation 708 (e.g., as described in sub-step 604 of FIG. 6A) to improve the detection accuracy. For example, the AI server 104 can mark and display the determined indicator fields on the UI 106. The user can verify the determined indicator fields and provide feedback via the UI 106. For example, the user can delete an incorrectly identified indicator field or drawing a box around a missed indicator field, so that the AI server 104 can correct a mistake or perform indicator field detection again based on the feedback.

At operation 720, the system can store the locations of the indicator fields (e.g., in an array X as described in sub-step 605 of FIG. 6A).

At operation 722, the system can recognize (e.g., using the AI server 104) item names in the image. For example, the recognition can be based on OCR techniques as described in sub-step 606 of FIG. 6B. In some implementations, the system can verify the recognized item names through interactions with the user (e.g., via the UI 106 as described in sub-step 606 of FIG. 6B).

At operation 724, the system can determine (e.g., using the AI server 104) items based on the recognized item names and an item database (e.g., as described in sub-step 607 of FIG. 6B). For example, each item can be assigned with an item identification (ID) in the item database. The system can access the item database through an API and query for the item IDs using character strings similar to, or the same as, those recognized in operation 722 (e.g., using AI NLP techniques). In some implementations, the system can verify the determined item IDs through interactions with the user (e.g., via the UI 106 as described in sub-step 607 of FIG. 6B). The system can store the determined item IDs (e.g., in the array X as described in sub-step 607 of FIG. 6B).

FIG. 9 illustrate an example process 900 of the recognition step (e.g., the recognition step 502 of FIG. 5). The process 900 can include sub-steps 901-905 described in detail as below.

Sub-step 901 can include capturing, using a camera or scanner (e.g., the image sensor 102 of FIG. 1), a photo or scanned document of a filled page of the ordering menu. For example, the filled page can be a copy of the ordering menu 200 that is filled or marked by a customer.

Sub-step 902 can include preprocessing, using an AI server (e.g., the AI server 104 of FIG. 1), the photo or scanned document. For example, this preprocessing work can be similar to the sub-step 602 of FIG. 6A and can include one or more of the following operations.

1. Correcting the photo or scanned document to keep the menu image straight.

2. Converting the image to binary, which involves removing colors to retain only a grayscale image.

3. Implementing other processes to assure image clarity. For example, shadows can be removed from the images.

Sub-step 903 can include processing, using the AI server, the photo or scanned document for recognition. This processing work can involve, for example, one or more of the following operations.

1. Referring to an array X generated in the registration step (e.g., the registration step 501 of FIG. 5) to read the coordinates of the bounding rectangle for each checkbox. Using the preprocessed image from sub-step 902, an image of each checkbox at the corresponding positions (e.g., within the bounding rectangle coordinates) can be cropped out (e.g., using the model 1202 of FIG. 12) based on the bounding rectangle coordinates in array X.

2. Determining whether the checkboxes at those positions have been marked. Any suitable methods for recognition of the marked checkboxes can be applied to this operation, which include but are not limited to the following two examples.

a. Employing OpenCV graphic functions to determine whether there have been changes in the bounding rectangle of the checkbox. If the pixels have changed, that can indicate a mark; if they have not, that can indicate an absence of marking. In some instances, to improve accuracy, a specialized algorithm (e.g., the object similarity model 1203 of FIG. 12) is designed to eliminate pixel differences caused by variations between two photography sessions. This algorithm can allow to accurately discern pixel differences that arise due to marking the checkbox, rather than pixel variations that can be caused by taking two separate photographs of the same page.

b. Utilizing deep learning recognition technologies such as models trained with the You Only Look Once (YOLO) object detection system (e.g., the model 1204 of FIG. 12), to discriminate between checkboxes that are checked and unchecked.

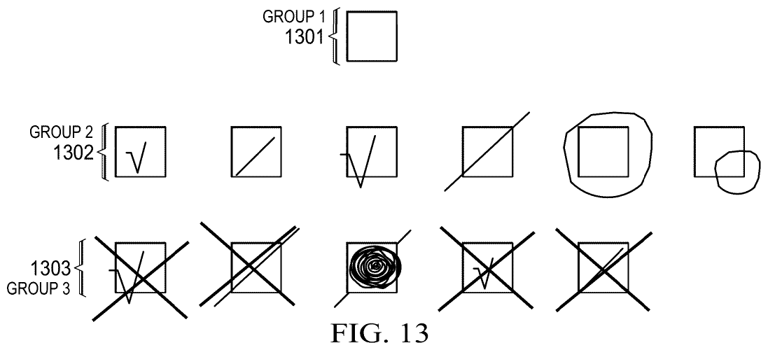

In some implementations, the customer may check a checkbox and then may obscure it with a pen. In this case, pixel changes occur, even though the item is not selected. To better handle this case, some variations or modifications can be applied to the above methods. For example, for the first method, a maximum pixel difference threshold can be set to determine if the checkbox has been obscured. For the second method, a data labeling approach (e.g., as shown below in FIG. 13) can be employed to train the model so that the model can automatically recognize the action as obscuring rather than selecting.

Based on the recognition results, an array Y is generated:

Y=[i,e,m],

where i is the checkbox sequence number, e is a Boolean value representing whether the corresponding checkbox is selected or not, and m is the quantity.

Sub-step 904 can include, based on the array X created in the registration step (e.g., the registration step 501 of FIG. 5), using the value of i in array Y to query the corresponding d in X, thereby generating the order array:

Z=[d,m].

Sub-step 905 can include displaying (e.g., via the UI 106) content of the ordering array (e.g., dish/product names and quantities) to the user. The user can provide feedback to modify and confirm the content of the ordering array. The final confirmed order can be submitted to an order database (e.g., the order database 108 of FIG. 1) through an API.

While in some examples of the present disclosure, the registration step 501 and the recognition step 502 of FIG. 5 are described in the context of an ordering menu with only one page, it is understood that this is merely one example and is not intended to be construed in a limiting sense. For example, the steps described above or variations of these steps also can be applicable to cases where the ordering menu has multiple pages or where the restaurant/store has multiple ordering menus of different types. In these cases, the registration step can be repeated for multiple times (e.g., as described in the method 700 with reference to FIGS. 7A-7C). Each time, the registration step can be applied to a respective page of the multiple pages (regardless of whether the multiple pages belong to the same ordering menu or multiple different ordering menus) to generate a template of that page. In some implementations, a user may manually turn a page to scan front and back sides of the page. In some other implementations, a more advanced scanner can be used and can have the ability to load and scan both sides of the page automatically. The template can include a photo of the corresponding page (e.g., the one obtained at the sub-step 602 of the registration step) and an array X of the corresponding page (e.g., the one obtained at the sub-step 607 of the registration step). As such, a plurality of templates associated with the multiple pages can be generated in the registration steps. In some implementations, the plurality of templates can be saved to the menu/product database or to any other suitable databases.

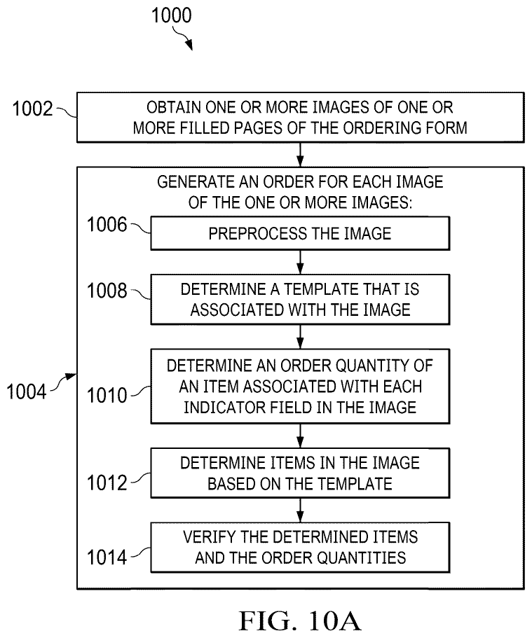

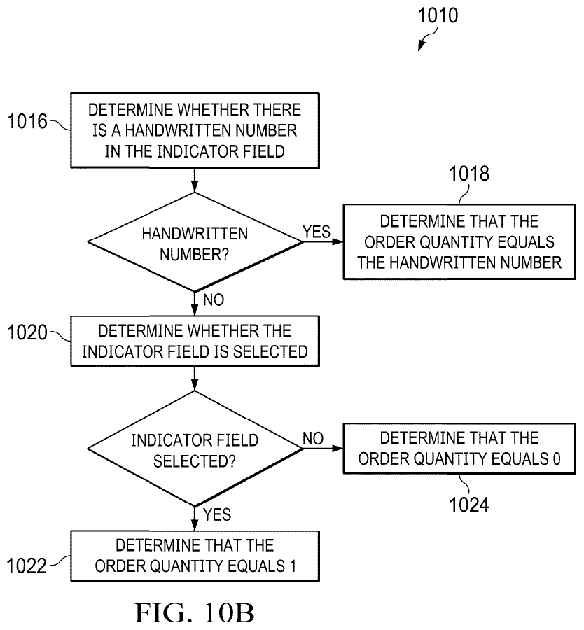

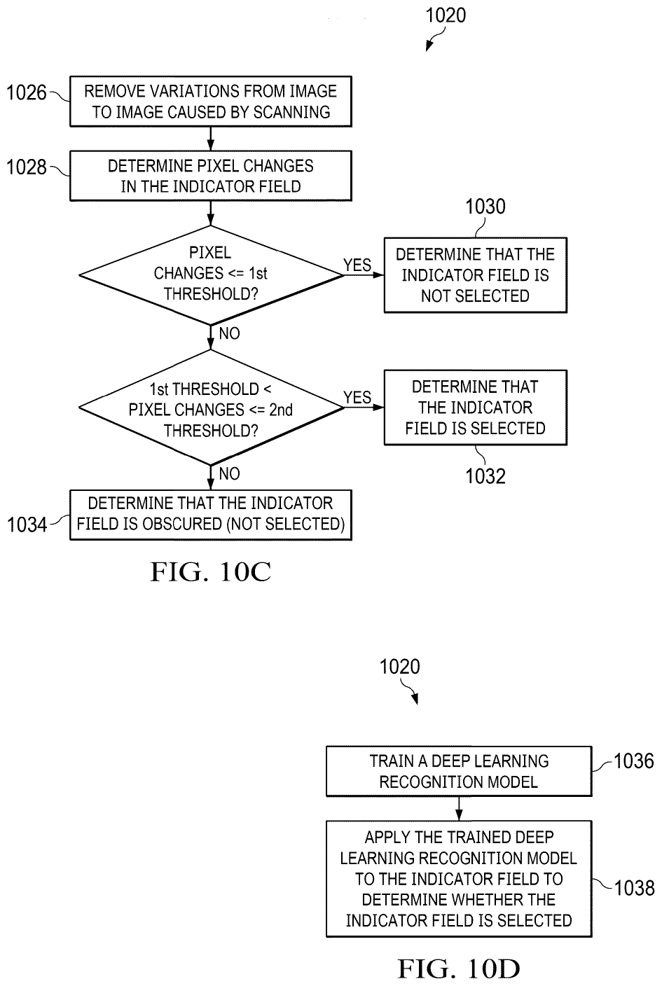

Similarly, the recognition step also can be repeated for multiple times to process multiple pages the customer filled out (e.g., as described below in the method 1000 with reference to FIGS. 10A-10D). These multiple pages can belong to the same ordering menu or different ordering menus. For example, a customer of a Japanese restaurant can order food from both a sushi menu and a regular dinner menu. For each page, an identification can be made as to which template the page is related to so that an array X corresponding to the page can be retrieved. In some implementations, the identification can be performed manually by a waiter of the restaurant. In some implementations, the identification can be performed automatically as an extra sub-step of the recognition step. For example, the automatic identification can be performed before the sub-step 903 of the recognition step and can be performed using the preprocessed photo of the filled page that is obtained at the sub-step 902 of the recognition step. The automatic identification can compare a photo of the filled page to the plurality of templates by performing a statistic analysis of the probability of a match. The comparison can be based on a portion of the filled page and each template including but not limited to a head, a page number, a watermark, or any combination thereof. In some implementations, results of the automatic identification can be provided to the waiter for verification, and the waiter can have an option to make a change when an identification error occurs.

In some implementations, the ordering menus filled by customers sitting at the same table can be aggregated and be processed as an entire order. When the waiter receives the filled menus from the customers, the waiter can write information on each individual menu to indicate which customer filled that menu. For example, the waiter can write down a customer's seating number on the menu filled by the customer. The system can automatically recognize the additional information added by the waiter and use that information to link a food or a dish to the customer who ordered it. In some implementations, erasable or dry erase menus or order sheets can be used repeatedly to avoid waste. For example, once the order is submitted, those sheets can be cleared and then can be provided to another customer for a new order.

FIGS. 10A-10D illustrate a flow chart of an example method 1000 for the recognition step (e.g., the recognition step 502 of FIG. 5). Method 1000 can be performed by any suitable device or system including, for example, the system 100 of FIG. 1.

As shown in FIG. 10A, at operation 1002, the system can obtain (e.g., using the image sensor 102 of FIG. 1) one or more image of one or more filled pages of the ordering form. A filled page of the ordering form may include an indicator field that is filled or marked by a customer. In some instances, the customer may write a checkmark in the indicator field to indicate that an item corresponding to the indicator field is being ordered. In some instances, the customer may write a number in or adjacent to the indicator field to indicate a quantity of that item the customer intends to order.

At operation 1004, the system can generate (e.g., using the AI server 104) an order for each of the one or more images. In some implementations, as shown in FIG. 10A, a respective order for each image can be generated by performing operations 1006, 1008, 1010, 1012, and 1014. For example, the order for each image can be determined based on the image and one or more templates of the ordering form. The one or more templates can be generated according to the registration step (e.g., the method 700 described with reference to FIGS. 7A-7C).

At operation 1006, the system can preprocess (e.g., using the AI server 104) the image to make the image suitable for the following operations. For example, the system can use the AI server 104 to preprocess the image as described in sub-step 902 of FIG. 9.

At operation 1008, the system can determine (e.g., using the AI server 104) a template that is associated with the image. In some implementations, the system can automatically and without user input, identify, using a statistic comparison algorithm, a template from the one or more templates that is corresponding to the image. For example, the automatic identification can compare the image to the one or more templates by performing a statistic analysis of the probability of a match. The comparison can be based on a respective portion of the image and each template. The portion can include but is not limited to a head, a page number, a watermark, or any combination thereof. In some implementations, user interactions can be performed to improve the accuracy of the identification. For example, results of the automatic identification can be provided (e.g., via the UI 106) to a user (e.g., a waiter of a restaurant) for verification, and the user can have an option to make a change (e.g., via the UI 106) when detecting an identification error.

At operation 1010, the system can determine (e.g., using the AI server 104) an order quantity of an item associated with each indicator field in the image. The indicator fields in the image can be determined based on locations of indicator fields in the identified template (e.g., as described in sub-step 903 of FIG. 9).

FIG. 10B illustrates a flow chart of an implementation of the operation 1010 for determining the order quantity of the item associated with the indicator field. At operation 1016, the system can determine (e.g., using the handwritten numeral recognition model 1205 in FIG. 12) whether there is a handwritten number in the indicator field. In response to determining a handwritten number in the indicator field, the flow chart proceeds to operation 1018, where the system can determine that the order quantity of the item equals the handwritten number. Otherwise, the flow chat can proceed to operation 1020, where the system determines whether the indicator field is selected. In response to determining that the indicator field is selected, the system can determine that the order quantity of the item equals one. Otherwise, the system can determine that the order quantity of the item equals zero.

The operation 1020 can be performed as described in sub-step 903 of FIG. 9. In some implementations, operation 1020 can be performed based on detecting (e.g., using OpenCV graphic functions) pixel changes in the indicator fields between the image and the template. FIG. 10C illustrates a flow chart of such an implementation. At operation 1026, the system can remove variations from image to image caused by scanning or taking a picture of the ordering form. This operation can allow the system to accurately discern pixel differences that arise due to marking the indicator field, rather than pixel variations that occur during taking two separate photographs. At operation 1028, the system can determine the pixel changes in the indicator field and compare the pixel changes to a first threshold and a second threshold. The second threshold can be larger than the first threshold. If the pixel changes are smaller than the first threshold, the flow chart proceeds to operation 1030, where the system can determine that the indicator field is not selected. If the pixel changes are larger than the first threshold and smaller than the second threshold, the flow chart proceeds to operation 1032, where the system can determine that the indicator field is selected. Otherwise, if the pixel changes are larger than the second threshold, the flow chart proceeds to operation 1034, where the system can determine that there is a correction in the indicator field and the indicator field is still not selected. In other words, the pixel changes larger than the second threshold can be caused by selecting the indicator field and then making a correction to obscure the selection.

In some implementations, operation 1020 can be performed based on deep learning recognition technologies (e.g., YOLO object detection). FIG. 10D illustrates a flow chart of an implementation of the operation 1020 based on deep learning. At operation 1036, the system can train a deep learning recognition model (e.g., the model 1204 of FIG. 12). FIG. 13 illustrates some training data examples. The training data can include image 1301 representing an unselected indicator field and images 1302 representing selected indicator fields. The training data can further include images 1303, which represent different variations of indicator fields being obscured. At operation 1038, the system can apply the trained deep learning recognition model to the indicator field to determine whether the indicator field is selected.

Returning to method 1000 of FIG. 10A, at operation 1012, the system can determine (e.g., using the AI server 104) the items in the image based on the identified template. For example, the system can determine the item ID based on the identified template as described in sub-step 904 of FIG. 9.

At operation 1014, the system can verify the determined items and the order quantities with the user (e.g., via the UI 106 as described in sub-step 905 of FIG. 9). After the order for each image is verified, the system can aggregate the orders and submit the aggregated order to an order database (e.g., the order database 108 of FIG. 1).

FIG. 11 shows example models and data flows for the registration step. Model 1100 is a document scanning correction model. The document scanning correction model can be designed to correct the scanned images. For example, the model 1100 can perform an angle correction (e.g., straightening a skewed image so that the text appears vertical).

Model 1101 is a binarization algorithm that converts color images into binary black and white images.

Model 1102 is an AI algorithm for identifying various types of checkboxes. Different algorithms can be used for this purpose. For example, one can be OpenCV's automatic geometric shape recognition algorithm, and the other can be YOLO's object detection algorithm. The first algorithm can be used in at least two ways: fully automatic recognition and recognition based on a user-defined area to identify unique geometric shapes. The algorithm used in the present disclosure can be specially designed. It is understood that these two options are merely examples, and that any suitable solution can be applied here.

Model 1103 is a geometric shape recognition algorithm that, based on a given geometric shape, searches for geometric shapes similar or identical to the given one. That is, if OpenCV's automatic recognition algorithm is used in model 1102 and shapes are identified based on user-defined areas, then the algorithm searches for all similar geometric shapes throughout the image. Model 1103 can be a customized algorithm.

Model 1104 is an AI OCR model for the recognition of dish/product names, which can utilize, for example, AWS's text recognition OCR service.

Model 1105 is an AI NLP algorithm that may use models such as Bidirectional Encoder Representations from Transformers (BERT) or any other suitable large language models to assess the similarity of dish names.

FIG. 12 shows example models and data flows for the recognition step. Models 1200 and 1201 in FIG. 12 can be similar to or the same as the models 1100 and 1101 in FIG. 11, respectively.

Model 1202 is a position search algorithm, which rapidly finds all positions on the image based on the checkbox locations stored in the database. If blurring causes missing boxes, the position search algorithm can compensate for the lost checkboxes based on the relative positions of all checkboxes.

Model 1203 is an object similarity algorithm for comparing the similarity between checkboxes filled out by the user and those in the template. High similarity indicates that the user has not made a selection; low similarity suggests that a choice has been made. This algorithm is specifically designed for use in the present disclosure.

Model 1204 is based on the YOLO model, which has been trained for discerning whether checkboxes have been marked or not. In the present disclosure, a custom YOLO model can be trained with specially marked data to recognize the status of checkboxes.

Model 1205 is a handwritten numeral recognition model used to identify the handwritten quantity specified by the user, which in this case can employ the AWS OCR model.

FIG. 13 illustrates example training data for the custom YOLO model. Image 1301 represents an indicator field that has not been selected or checked. Images 1302 include indicator fields that have been checked. As shown, different manners of providing the checks or selections can be expected, so training on different types of selections can result in accurate detections. The selected illustrations in images 1302 are not limiting and are merely an example. In some instances, a complete shading in the indicator field may be considered as a selection, although in other cases, it may be considered as an attempt to remove an accidental or reconsidered check (see, e.g., the filled in box in one of images 1303). Images 1303 illustrate indicator fields that are obscured after they have been checked, which is equivalent to not being checked. Again, training on the types of obscuring or correction can be used to identify examples. In some instances, if the confidence level of a particular mark is not sufficiently high after the AI analysis is performed, the user (e.g., a waiter or a salesperson) can be prompted via the UI to confirm or correct the assumption of a particular entry. In some instances, the customer's other entries may also be considered in determining whether a particular entry or mark is a selection or an intent to remove a selection. If the user has filled in multiple entries on the menu without other types of checks or indications, the system may determine that such marks are the user's attempt to select those items.

The present disclosure provides techniques that automate the input of ordering menu form in catering and other service venues, changing the way this order input processing is handled in such establishments. Implementations of the present disclosure can provide one or more of the following technical advantages and/or benefits.

### 1. Save Time/Effort

In some instances, the entry of ordering menu form is still done manually. That is, the waiter holds the ordering menu form in one hand and operates the POS machine in the other hand. They then create an order on the POS machine, open the Order editing interface, enter the item ordered on the form one by one, and click save. The time taken to enter an order form can be about 2 minutes, depending on the convenience of the POS system. However, using the techniques described in the present disclosure, the processing time of the ordering menu form can be only 10 seconds, greatly saving time and effort.

### 2. Accuracy

Ordering menu form entry is often prone to error due to human fatigue and mistakes. AI, on the other hand, is more accurate, and the techniques described in the present disclosure have improved the accuracy of ordering menu form entry.

### 3. Productivity

Compared to manual entry of ordering menu form, the techniques described in the present disclosure can greatly improve productivity. The production efficiency of catering and other service venues is significantly enhanced. Traditional OCR technology can recognize text but cannot recognize checked boxes on the form. Users, such as waiters or salespersons, may still need to look from the form and enter on the machine, resulting in low production efficiency.

Implementations of the present disclosure can be used in entry of ordering menu form in restaurants, retail shop, and other businesses. The solution can be integrated into the POS system or run independently. With suitable adjustment or customization, implementations of the present disclosure can also be used for scanning of investigation forms and automatic entry of investigation forms. An example of the investigation forms can be a medical history form that a patient fills out when visiting a doctor. The medical history form can include one or more of a list of medical issues or conditions the patient is having, personal health history or family health history of the patient. In some instances, the patient can provide medical history information by checking some checkboxes in the medical history form.

The following is an example application process. Step 1 is the registration of order form. For example, step 1 can include 5 sub-steps.

1. The user take a photo or scan an empty paper order form.

2. The application shows the photo to user. User Encircles the checkbox with a frame.

3. The AI server processes the photo and analyses it, and recognizes checkboxes on the paper order form. At the same time, the AI server recognizes item names near or associated with each checkbox.

4. The application saves the checkbox information into database. The information can include, among other information, an index and coordinate of the particular checkbox.

5. The application matches the item names with the item names searched from a related database. The application can build relationships between particular checkboxes and corresponding item names in the related database, and can then save the relationship into the same database, or a separate database or table. The final information in the database can then include, for example, an index, a corresponding coordinate, and an item_id. The item_id is the ID number in the related database.

Step 2 is the scan and recognize step of order form. For example, step 2 can include 4 sub-steps.

1. The user takes a photo or scan a paper order form checked/written by the customer.

2. The AI server processes the photo and analyses it, recognizes the checkboxes checked on the paper order form and/or any numbers written on the form.

3. The application shows the recognized result on the screen. The user can, if needed, modify the result, and can confirm with the final result. In some instances where the confidence level exceeds a confidence threshold, the application may automatically accept the analysis as correct without asking for user confirmation.

4. The application generates the order information including Item name, and can share and save that information in a corresponding database. In some instances, the order may be placed into a POS system, or other suitable order system, where the order can be processed. In some instances, that can include immediate order preparation, while in others, the order can be placed into a queue for completion.

Embodiments of the subject matter and the operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification, the different functions can be implemented using “engines,” which broadly refer to software-based systems, subsystems, or processes that are programmed to perform one or more specific functions. Generally, an engine is implemented as one or more software modules or components, installed on one or more computers, in one or more locations. In some cases, one or more computers can be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing models described in this specification can also include, for example, special-purpose hardware accelerator units for processing common and compute-intensive parts of machine learning training or production, i.e., inference, workloads. Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any disclosure or on the scope of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claim in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described in this specification. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, comprising:
obtaining, using an image sensor, an image of a first page of an ordering form, wherein the ordering form comprises one or more pages, each page comprises names of items and indicator fields, and at least one indicator field of the first page is marked to indicate a corresponding item being ordered;
determining an order based on the image of the first page and one or more templates associated with the one or more pages of the ordering form, wherein the order comprises one or more items selected on the first page of the ordering form, and each template comprises items and locations of indicator fields associated with a corresponding page of the ordering form; and
transmitting the determined order to an order processing system.

2. The method of claim 1, wherein determining the order comprises:
automatically and without user input, identifying, using a statistic comparison algorithm executed by the one or more computers, a template from the one or more templates that is corresponding to the image of the first page;
determining items in the image of the first page based on items in the identified template;
determining indicator fields in the image of the first page based on locations of indicator fields in the identified template; and
for each indicator field in the image of the first page, determining an order quantity of an item indicated by the indicator field.

3. The method of claim 2, wherein determining the order quantity of the item indicated by the indicator field comprises:
determining whether the indicator field is selected; and
determining that the order quantity of the item is one in response to determining that the indicator field is selected.

4. The method of claim 3, wherein determining whether the indicator field is selected comprises:
determining whether the indicator field is selected using an algorithm to detect a change in an image of the indicator field caused by a selection of the indicator field.

5. The method of claim 3, wherein determining whether the indicator field is selected comprises:
determining whether the indicator field is selected using a deep learning recognition algorithm and training data, wherein the training data comprises at least one of:
an image of an unselected indicator field;
an image of a selected indicator field; and
an image of an indicator field that is selected by a mistake and has a correction to fix the mistake.

6. The method of claim 2, wherein determining the order quantity of the item indicated by the indicator field comprises:
recognizing a handwritten number filled in the indicator field using optical character recognition (OCR); and
determining that the order quantity of the item is the recognized handwritten number.

7. The method of claim 2, wherein determining the order further comprises:
displaying the order to a user; and
updating the order in response to receiving an input from the user to modify the order.

8. The method of claim 1, wherein the ordering form comprises forms of different types, and each of the forms of different types comprises at least one page.

9. The method of claim 1, further comprising:
obtaining an image of a second page of the ordering form; and
automatically and without user input, identifying, using a statistic comparison algorithm executed by the one or more computers, a second template from the one or more templates that is corresponding to the image of the second page, wherein the order is determined further based on the image of the second page and the second template, and the order further comprises at least another item selected on the second page.

10. The method of claim 1, wherein each of the items comprises at least one of a product or a service, the product comprises a food, and the ordering form comprises a restaurant menu.

11. The method of claim 1, wherein each template is generated by:
obtaining an image of a corresponding page of the ordering form;
recognizing item names in the image of the corresponding page using OCR;
determining items based on the recognized item names and an item database; and
determining locations of indication fields in the image of the corresponding page.

12. The method of claim 11, wherein determining the locations of the indication fields in the image of the corresponding page comprises:
automatically detecting the indication fields in the image of the corresponding page based on at least one of a geometric shape detection algorithm or a deep learning object recognition algorithm.

13. The method of claim 11, wherein determining the locations of the indication fields in the image of the corresponding page comprises:
displaying the image of the corresponding page to a user;
receiving a user input representing at least one indication field in the image of the corresponding page that is identified by the user; and
determining the locations of the indication fields in the image of the corresponding page based on the at least one indication field identified by the user.

14. A system comprising:
an image sensor;
one or more computers; and
one or more storage devices storing instructions that when executed by the one or more computers cause the one or more computers to perform operations comprising:
obtaining, using the image sensor, an image of a first page of an ordering form, wherein the ordering form comprises one or more pages, each page comprises names of items and indicator fields, and at least one indicator field of the first page is marked to indicate a corresponding item being ordered;
determining an order based on the image of the first page and one or more templates associated with the one or more pages of the ordering form, wherein the order comprises one or more items selected on the first page, and each template comprises items and locations of indicator fields associated with a corresponding page; and
transmitting the order to an order processing system.

15. The system of claim 14, wherein determining the order comprises:
automatically and without user input, identifying, using a statistic comparison algorithm, a template from the one or more templates that is corresponding to the image of the first page;
determining items in the image of the first page based on items in the selected template;
determining indicator fields in the image of the first page based on locations of indicator fields in the selected template; and
for each indicator field in the image of the first page, determining an order quantity of an item indicated by the indicator field.

16. The system of claim 15, wherein determining the order quantity of the item indicated by the indicator field comprises:
determining whether the indicator field is selected; and
determining that the order quantity of the item is one in response to determining that the indicator field is selected.

17. The system of claim 16, wherein determining whether the indicator field is selected comprises:
determining whether the indicator field is selected using an algorithm to detect a change in an image of the indicator field caused by a selection of the indicator field.

18. The system of claim 16, wherein determining whether the indicator field is selected comprises:
determining whether the indicator field is selected using a deep learning recognition algorithm and training data, wherein the training data comprises at least one of:
an image of an unselected indicator field;
an image of a selected indicator field; and
an image of an indicator field that is selected by a mistake and has a correction to fix the mistake.

19. The system of claim 15, wherein determining the order quantity of the item indicated by the indicator field comprises:
recognizing a handwritten number filled in the indicator field using optical character recognition (OCR); and
determining that the order quantity of the item is the recognized handwritten number.

20. A non-transitory computer-readable storage medium storing instructions that when executed by one or more computers cause the one or more computers to perform operations comprising:
obtaining, using an image sensor, an image of a first page of an ordering form, wherein the ordering form comprises one or more pages, each page comprises names of items and indicator fields, and at least one indicator field of the first page is marked to indicate a corresponding item being ordered;
determining an order based on the image of the first page and one or more templates associated with the one or more pages of the ordering form, wherein the order comprises one or more items selected on the first page, and each template comprises items and locations of indicator fields associated with a corresponding page; and
transmitting the order to an order processing system.
